(19) United States
(12) Patent Application Publication
(10) Pub. No.: US 2022/0413667 A1
(43) Pub. Date: Dec. 29, 2022

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Maiko SEKIGUCHI, Kanagawa (JP)

(73) Assignee: FUJIFILM Business Innovation Corp., Tokyo (JP)

(21) Appl. No.: 17/539,198

(22) Filed: Dec. 1, 2021

(30) Foreign Application Priority Data
Jun. 25, 2021 (JP) 2021-105858

(51) Int. Cl. G06F 3/0484; G06F 3/0482

(52) U.S. Cl. CPC G06F 3/0484; G06F 3/0482

(57) ABSTRACT

An information processing apparatus includes a processor configured to display a first file necessary for work for a role of a user in performing an activity having a specific purpose, among files shared and worked on by plural users, and change a position at which the first file is displayed, depending on the role.

### CROSS-REFERENCE TO RELATED APPLICATIONS

This application is based on and claims priority under 35 USC 119 from Japanese Patent Application No. 2021-105858 filed Jun. 25, 2021.

### BACKGROUND

### (i) Technical Field

The present invention relates to an information processing apparatus, a non-transitory computer readable medium storing a program, and an information processing method.

### (ii) Related Art

JP2000-172669A discloses an apparatus that saves the current and previous states of a workspace together with history information of an operation performed on the workspace and combines pieces of history information in accordance with a combining rule to generate overview information.

### SUMMARY

In order to perform an activity for a specific purpose, a file of document data, image data, sound data, or the like may be displayed for a plurality of users, and the plurality of users may share the file to work. A role to perform the activity may be assigned to each user. In this case, in a case where all the shared files are disposed and displayed at the same position for all users regardless of the role assigned to each user, it may be difficult to specify the file necessary for the work depending on the user having the role.

Aspects of non-limiting embodiments of the present disclosure relate to an information processing apparatus, a non-transitory computer readable medium storing a program, and an information processing method for facilitating specifying of a file necessary for work in comparison to a case where all files are disposed and displayed at the same position for all users regardless of a role assigned to each user.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to display a first file necessary for work for a role of a user in performing an activity having a specific purpose, among files shared and worked on by a plurality of users, and change a position at which the first file is displayed, depending on the role.

### BRIEF DESCRIPTION OF THE DRAWINGS

Exemplary embodiment(s) of the present invention will be described in detail based on the following figures, wherein:

FIG. 1 is a block diagram illustrating a configuration of an information processing system according to an exemplary embodiment;

FIG. 2 is a block diagram illustrating a configuration of a server;

FIG. 3 is a block diagram illustrating a configuration of a terminal device;

FIG. 4 is a block diagram illustrating a database;

FIG. 5 is a diagram illustrating an outline of processing according to the exemplary embodiment;

FIG. 6 is a flowchart illustrating a flow of the processing according to the exemplary embodiment;

FIG. 7 is a diagram illustrating a setting screen of a role;

FIG. 8 is a diagram illustrating the setting screen of the role;

FIG. 9 is a diagram illustrating the setting screen of the role;

FIG. 10 is a diagram illustrating the setting screen of the role;

FIG. 11 is a diagram illustrating a screen showing a list of shared workspaces;

FIG. 12 is a diagram illustrating a setting screen of a work content;

FIG. 13 is a diagram illustrating a screen showing the shared workspace;

FIG. 14 is a diagram illustrating a list of roles;

FIG. 15 is a diagram illustrating the screen showing the shared workspace;

FIG. 16 is a diagram illustrating a notification setting screen;

FIG. 17 is a diagram illustrating the notification setting screen;

FIG. 18 is a diagram illustrating the screen showing the shared workspace;

FIG. 19 is a diagram illustrating contents of a file;

FIG. 20 is a diagram illustrating a work content assignment screen;

FIG. 21 is a diagram illustrating the work content assignment screen;

FIG. 22 is a diagram illustrating the screen showing the shared workspace; and

FIG. 23 is a diagram illustrating an image of the screen showing the shared workspace.

### DETAILED DESCRIPTION

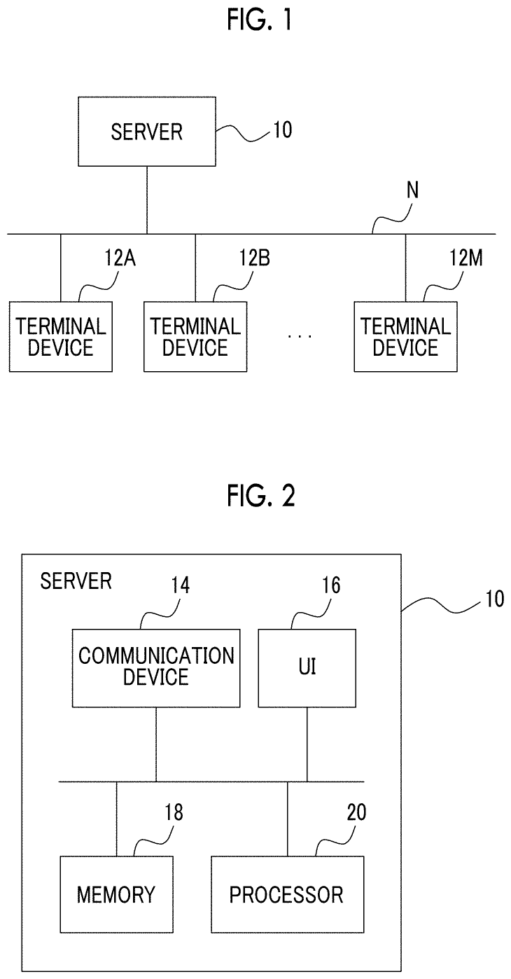

An information processing system according to an exemplary embodiment will be described with reference to FIG. 1. FIG. 1 illustrates an example of a configuration of the information processing system according to the exemplary embodiment.

The information processing system according to the exemplary embodiment includes a server 10 and terminal devices. In the example illustrated in FIG. 1, the information processing system includes terminal devices 12A, 12B, . . . , 12M, for example. In a case where it is not necessary to distinguish the terminal devices 12A, 12B, . . . , and 12M from each other, it is assumed that the terminal devices 12A, 12B, . . . , and 12M are referred to as a “terminal device 12” below. The number of the servers 10 and the number of the terminal devices 12 illustrated in FIG. 1 are merely an example, and the number of the server 10 and the number of the terminal devices 12 are not limited.

The server 10 and the terminal device 12 have a function of communicating with other devices. The communication may be a wired communication using a cable or a wireless communication. That is, each device may be physically connected to another device by the cable to transmit and receive information, or may transmit and receive information by a wireless communication. A wireless communication includes, for example, a short-range wireless communication, Wi-Fi (registered trademark), and the like. The short-range wireless communication includes, for example, Bluetooth (registered trademark), a radio frequency identifier (RFID), and the like. In the example illustrated in FIG. 1, as an example, each device communicates with another device via a communication path N such as a local area network (LAN) or the Internet.

The server 10 provides users with a shared workspace shared by a plurality of users, in which the plurality of users work. The shared workspace is a space in which a plurality of users share files, folders, and functions to work. The shared workspace may be formed on a virtual space, for example. In a case where the shared workspace is used, a screen showing the shared workspace is displayed on the terminal device 12 of a user who uses the shared workspace.

The server 10 may provide the user with a personal workspace. The personal workspace is a workspace associated with an individual user, and is a space in which the user works individually. In a case where the personal workspace is used, a screen showing the personal workspace is displayed on the terminal device 12 of the user who uses the personal workspace.

The category of the concept of a file includes image data, moving image data, graphic data, sound data such as music data and audio data, document data such as text data, and a program. The format of the file is not particularly limited, and a file having any format may be set as a work target. The format of the file as a work target is limited, and only the file having a specific format may be the work target.

A folder is a place in which a file is stored. For example, there are a shared folder and a personal folder. The shared folder is shared by a plurality of users. The personal folder is associated with an individual user and used by the user individually.

The function is a function related to a process executed for a file or a folder, and a function for realizing another process or operation. The function may be realized by a program such as application software, or may be realized by hardware such as an electronic circuit. For example, application software for viewing and editing document data, image data, and the like being examples of the files, is an example of the function.

In the shared workspace, for example, a plurality of users share a file, a folder, and a function, and perform work such as editing and viewing a file.

In a case where the personal workspace is provided, in the personal workspace, a user associated with the personal workspace performs work such as editing and viewing a file.

Editing a file means changing the contents of the file or information (for example, metadata) attached to the file. Editing a file includes, for example, adding the contents of the file, deleting a portion of the contents, processing the contents, performing processing on the file, and changing the file name. For example, in a case where the file is document data, adding a text string to the document data, deleting a portion of the text string from the document data, and changing the color, the font, the size, and the like of the text correspond to an example of editing. In a case where the file is image data, performing image processing (for example, image processing, format conversion, compression, and brightness correction) on the image data corresponds to an example of editing. These are merely examples, and other processing and operations performed by the user may be included in the category of the concept of editing.

The server 10 may have a function other than the function of providing the shared workspace. The server 10 may function as a file server, a thin client server, a backup server, or the like. The server 10 may be physically one device, or may be configured by a plurality of physically different devices.

The terminal device 12 is, for example, a personal computer (referred to as a “PC” below), a tablet PC, a smartphone, a portable phone, or the like.

The hardware configuration of the server 10 will be described below with reference to FIG. 2. FIG. 2 illustrates an example of the hardware configuration of the server 10.

The server 10 includes, for example, a communication device 14, a UI 16, a memory 18, and a processor 20.

The communication device 14 is a communication interface having a communication chip, a communication circuit, and the like. The communication device has a function of transmitting information to another device and a function of receiving information from the other device. The communication device 14 may have a wireless communication function or a wired communication function. The communication device 14 may communicate with another device by using, for example, short-range wireless communication, or may communicate with another device via the communication path N.

The UI 16 is a user interface and includes a display and an input device. The display is a liquid crystal display, an EL display, or the like. The input device is a device such as a keyboard or a pointing device (for example, a mouse, a trackball, a touch pad, and a pen tablet). The UI 16 may be a UI such as a touch panel having both the display and the input device. The UI 16 may include a microphone and a speaker.

The memory 18 is a device that forms one or a plurality of storage areas for storing data. Examples of the memory 18 include a hard disk drive (HDD), a solid state drive (SSD), various types of memories (for example, RAM, DRAM, and ROM), other storage devices (for example, optical disk), and a combination thereof. One or a plurality of memories 18 are included in the server 10.

The processor 20 is configured to control the operation of the units in the server 10. The processor 20 may include a memory.

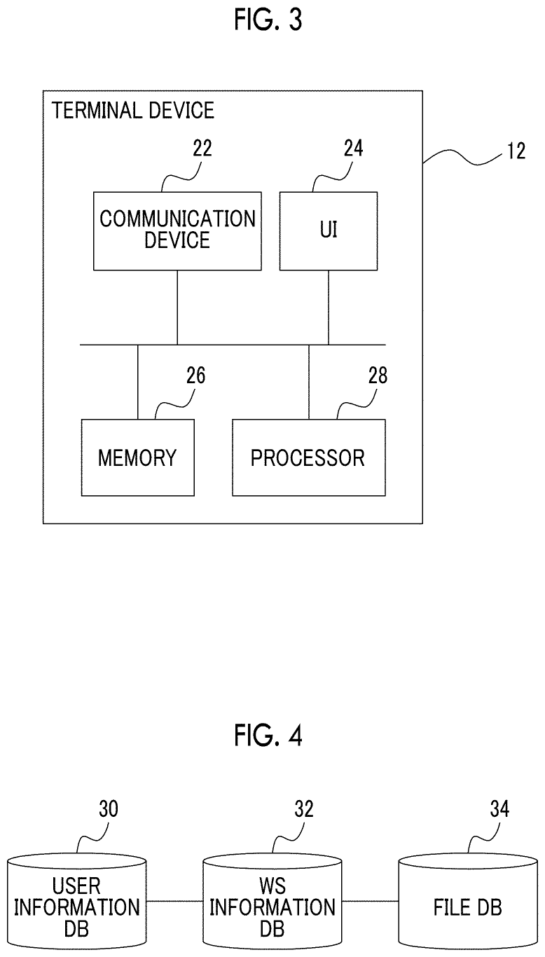

The hardware configuration of the terminal device 12 will be described below with reference to FIG. 3. FIG. 3 illustrates an example of the hardware configuration of the terminal device 12.

The terminal device 12 includes, for example, a communication device 22, a UI 24, a memory 26, and a processor 28.

The communication device 22 is a communication interface having a communication chip, a communication circuit, and the like. The communication device has a function of transmitting information to another device and a function of receiving information transmitted from the other device. The communication device 22 may have a wireless communication function or a wired communication function. The communication device 22 may communicate with another device by using, for example, short-range wireless communication, or may communicate with another device via a communication path such as a LAN or the Internet.

The UI 24 is a user interface and includes a display and an input device. The display is a liquid crystal display, an EL display, or the like. The input device is a device such as a keyboard or a pointing device (for example, a mouse, a trackball, a touch pad, and a pen tablet). The UI 24 may be a UI such as a touch panel having both the display and the input device. The UI 24 may include a microphone and a speaker.

The memory 26 is a device that forms one or a plurality of storage areas for storing data. Examples of the memory 26 include a hard disk drive (HDD), a solid state drive (SSD), various types of memories (for example, RAM, DRAM, and ROM), other storage devices (for example, optical disk), and a combination thereof. One or a plurality of memories 26 are included in the terminal device 12.

The processor 28 is configured to control the operation of the units in the terminal device 12. The processor 28 may include a memory.

In the present exemplary embodiment, the processor 20 in the server 10 provides the user with a shared workspace. For example, the processor 20 displays a screen showing the shared workspace on the display of the terminal device 12 of the user who uses the shared workspace.

The processor 20 causes a first file to be displayed on the display of the terminal device 12, and changes the position at which the first file is displayed, depending on a role. The first file is a file necessary for work of a role of a user while realizing an activity having a specific purpose, among files shared and worked on by a plurality of users. For example, the processor 20 displays the first file on a screen showing a shared workspace associated with an activity having a specific purpose, and changes the position at which the first file is displayed, depending on the role of the user.

Describing with a specific example, users B and C are participating in an activity having a specific purpose, and different roles are assigned to the users B and C in order to realize the activity. The processor 20 displays the screen showing the shared workspace associated with the activity, on the display of each of the terminal devices 12 of the users B and C. The processor 20 displays the file at a position corresponding to the role of the user B on the screen displayed on the display of the terminal device 12 of the user B, and displays the file at a position corresponding to the role of the user C on the screen displayed on the display of the terminal device 12 of the user C.

For example, the shared workspace is defined for each activity, and the screen showing the shared workspace is displayed on the display of the terminal device 12 for each activity. Each user works in the shared workspace associated with the activity in which the user participates. In order to use the shared workspace, the user may need to log in to the shared workspace. The user may be authenticated in log-in. For example, the same shared workspace associated with an activity is provided for a plurality of users participating in the same activity. The users who receive the same shared workspace can share and work a file, a folder, and a function in the shared workspace.

In a case where the first file in which work by the user B being an example of a first user has completed is forwarded to the user C being an example of a second user, the processor 20 may display the first file at a position corresponding to the role of the user C, for the user C. That is, the processor 20 displays the first file at the position corresponding to the role of the user C on the screen showing the shared workspace displayed on the display of the terminal device 12 of the user C. For example, the processor 20 displays the first file forwarded to the user C in an area in which the file requiring work is displayed on the screen.

The processor 20 may change the priority of the display of the file in accordance with the file. For example, in a case where a plurality of files are displayed to overlap each other, the processor 20 changes the position of each file among the plurality of files overlapping each other, in accordance with the file. Specifically, the processor 20 may display older files above the overlapping portion. The processor 20 may display files that require an urgent work, above the overlapping portion. Alternatively, the processor 20 may display the file with a notification described later, at the upper part of the overlapping portion. For example, the processor 20 changes the position of the first file among the plurality of files, in accordance with the first file included in the plurality of files overlapping each other. Depending on the number of files displayed on the screen showing the shared workspace, a plurality of files may be displayed to overlap each other. In this case, the processor 20 changes the position of each file among the plurality of files overlapping each other, in accordance with the file.

In a case where the role of a certain user (for example, a third user) is assigned to another user (for example, a fourth user) different from the user, the processor 20 may display the same contents as the contents displayed for the third user, for the fourth user. For example, the role of the third user may be handed over to the fourth user, the third user may withdraw from the activity and not participate in the activity any more, and the fourth user may perform work corresponding to the role in the activity. In this case, the processor 20 displays the contents displayed for the third user before the handover, for the fourth user. For example, the processor 20 causes the screen showing the shared workspace displayed on the display of the terminal device 12 of the third user to be displayed on the display of the terminal device 12 of the fourth user. For example, in a case where the third user adds information such as a text string or an image on the screen showing the shared workspace, the processor 20 displays the screen in a state where the added information is applied, on the display of the terminal device 12 of the fourth user. For example, in a case where the third user adds a memo or writes a text string on the screen showing the shared workspace, the processor 20 causes the screen showing the shared workspace displayed for the third user to be displayed on the display of the terminal device 12 of the fourth user, in a state where the added memo or the written text string remains. The processor 20 may change a portion of the contents that are not displayed for the third user and display the resultant for the fourth user.

The processor 20 may display a file corresponding to the role of the user on the screen showing the shared workspace. For example, the processor 20 displays a file corresponding to the role of the user B on the screen displayed on the terminal device 12 of the user B, and displays a file corresponding to the role of the user C on the screen displayed on the terminal device 12 of the user C. In a case where the role of the user B is different from the role of the user C, the file displayed for the user B may be different from the file displayed for the user C. Even in a case where the role of the user B is different from the role of the user C, the file displayed for the user B and the file displayed for the user C may be the same.

The activity is, for example, a project, a task, an event, a job, an operation, businesses, and a mission to achieve a certain goal. For example, the role is assigned to each user by a person who manages the activity (for example, an administrator). The role may be assigned to the user in advance. The content of the work corresponding to the role (for example, the content of the work to be performed by the user to which the role is assigned) may be assigned to each user by the administrator or assigned to the user by the user, for example.

The processor 20 may display a list of contents of work corresponding to the role of the user on the display of the terminal device 12 of the user, and associate the work content selected from the list with the user. For example, the user may select the content of the work to be performed by the user from the list, or the administrator may select the content of the work to be performed by the user from the list. The content of the work to be performed by the user may be defined in advance for each role, and the processor 20 may associate the content of the predefined work with the user.

The processor 20 may provide the user with the personal workspace. For example, the processor 20 displays a screen showing the personal workspace on the display of the terminal device 12 of the user associated with the personal workspace.

A database used in the information processing system according to the exemplary embodiment will be described below with reference to FIG. 4. FIG. 4 illustrates an example of the database.

For example, the information processing system includes a user information DB 30, a WS information DB 32, and a file DB 34. All or some of the user information DB 30, the WS information DB 32, and the file DB 34 may be provided in the server 10 or may be provided in a device other than the server 10.

The user information DB 30 is a database that manages information regarding users who participate in the activity. In the user information DB 30, for example, for each user, user identification information (for example, user ID, user name, name, and account) for identifying a user, activity identification information (for example, activity ID and activity name) for identifying an activity in which the user participates, workspace identification information (for example, workspace ID and name of a workspace) for identifying a shared workspace associated with an activity in which the user participates, role identification information (for example, role ID and role name) for identifying a role assigned to a user in an activity in which the user participates, and work content identification information for identifying a content of work to be performed in an activity by a user to which a role is assigned are associated with each other.

The WS information DB 32 is a database that manages information regarding the shared workspace. In the WS information DB 32, for example, for each shared workspace, workspace identification information for identifying a shared workspace, storage location identification information (for example, storage location ID, name of a storage location, and an address (for example, URL) of the storage location address) for identifying a storage location in which work or a file to be used is stored in the shared workspace, and role identification information for identifying a role to be performed in the shared workspace are associated with each other. The storage location of the file may be, for example, a folder.

The file DB 34 is a database that manages files. In the file DB 34, for example, a storage location identification information for identifying a storage location where a file is stored and file identification information (for example, file name and file ID) for identifying a file stored in the storage location are associated with each other. The file itself may be stored in the file DB 34.

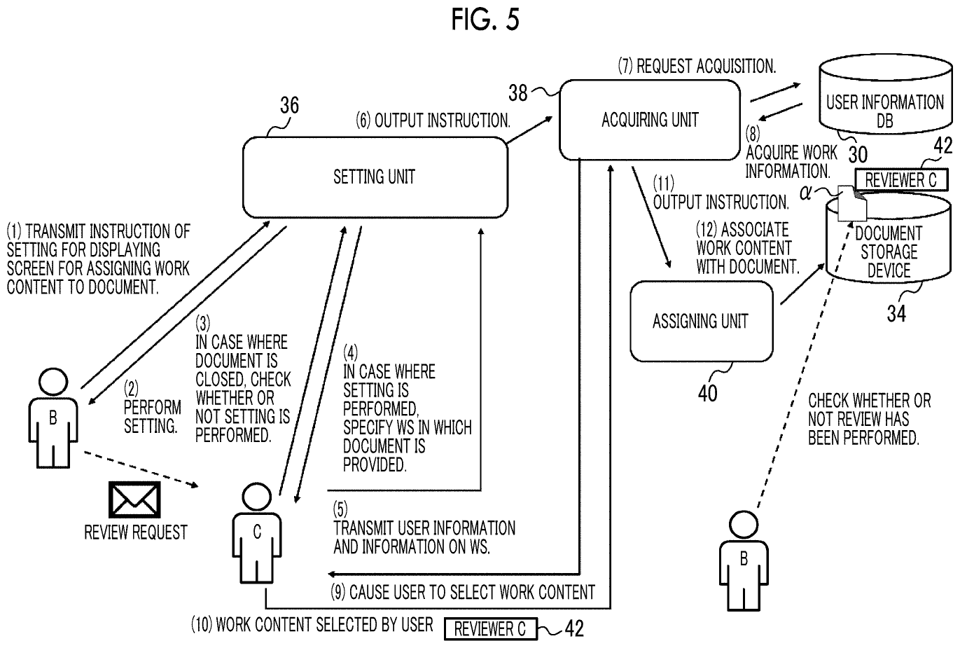

An outline of processing according to the exemplary embodiment will be described below with reference to FIG. 5. FIG. 5 illustrates the outline.

Here, as an example, users B and C are participating in the same activity and work by using a shared workspace associated with the activity. The user B requests the user C to review a document α being an example of the file. That is, the user B is a reviewee, and the user C is a reviewer.

A setting unit 36, an acquiring unit 38, and an assigning unit 40 are functions realized by the processor 20 of the server 10.

(1) First, the user B transmits an instruction of setting for displaying a screen for assigning the content of work to the document α by using the terminal device 12B of the user B. Assignment of the content of the work to the document α means, for example, association of work content identification information for identifying the content of the work with the document α. The information indicating the instruction is transmitted from the terminal device 12B to the setting unit 36 of the server 10. For example, the user B designates the document α to which the content of the work is assigned, and transmits the instruction for the setting. The user B requests the user C to review the document α. A requesting method is not limited. For example, e-mail, a social networking service (SNS), a telephone, or the like is used. The user B may face the user C and verbally request the user C for a review.

(2) In a case where the setting unit 36 receives the instruction transmitted by the user B, the setting unit 36 sets displaying of a screen for assigning the content of the work to the document α. For example, the setting unit 36 associates the document α with a setting for displaying the screen for assigning the content of the work to the document α.

(3) Then, in a case where the user C opens the document α and confirms the content by using the terminal device 12C of the user C, and then closes the document α, the setting unit 36 checks whether or not the document α is associated with a setting for displaying the screen for assigning the content of the work to the document α.

(4) In a case where the setting is associated with the document α, the setting unit 36 specifies the shared workspace (“WS” in FIG. 5) in which the document α is provided. For example, the setting unit 36 specifies the shared workspace in which the document α is used, by referring to the WS information DB 32 and the file DB 34.

(5) The processor 28 in the terminal device 12C of the user C transmits information (for example, user identification information of the user C) on the user C and information (for example, workspace identification information of the shared workspace) on the shared workspace used by the user C, to the setting unit 36.

(6) Then, the setting unit 36 transmits an instruction to execute a process to the acquiring unit 38.

(7) The acquiring unit 38 requests the user information DB 30 to acquire the information on the user C.

(8) The acquiring unit 38 acquires, for example, work content identification information for identifying the content of the work performed in the activity in which the user C participates, as the information on the user C, from the user information DB 30. The work content identification information indicates, for example, a list of the contents of the work performed by the user C.

(9) The work content identification information is displayed on the display of the terminal device 12C of the user C. The processor 20 causes the user to select the content of the work performed by the user C on the document α from the list of the content of the work indicated by the work content identification information.

(10) The processor 28 of the terminal device 12C transmits work content identification information for identifying the content of the work selected by the user C, to the acquiring unit 38. For example, in a case where the content of the work selected by the user C is a review of the document α, the user C selects the content of the work, called review. In this case, for example, information indicating that the user C has reviewed the document α (for example, information indicated by the reference sign 42 in FIG. 5) is included in the information indicating the content of the work, and then is transmitted to the acquiring unit 38.

(11) In a case where the acquiring unit 38 receives the work content identification information for identifying the content of the work from the terminal device 12C, the acquiring unit 38 transmits an instruction to associate the content of the work with the document α, to the assigning unit 40.

(12) The assigning unit 40 associates the document α with the work content identification information for identifying the content of the work performed by the user C. For example, the assigning unit 40 associates information indicating that the user C has reviewed the document α with the document α. In this manner, the content of the work is assigned to the document α. In the example illustrated in FIG. 5, the document α is stored in the file DB 34, and the information indicated by the reference sign 42 (for example, information indicating that the user C has reviewed the document α) is associated with the document α.

The user B can check whether or not the document α has been reviewed by the user C, by accessing the file DB 34 with the terminal device 12B and referring to the information associated with the document α. For example, in a case where the document α is reviewed by the user C, the document α is associated with the information indicating that the user C has reviewed the document α, so that the user B can check whether or not the document α has been reviewed by the user C, by checking whether or not such information is associated with the document α.

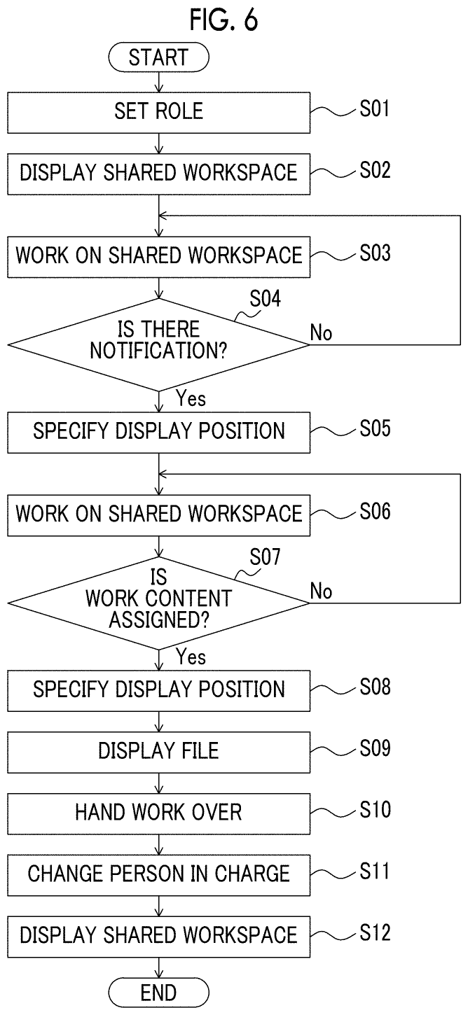

The processing according to the exemplary embodiment will be described below with reference to FIG. 6. FIG. 6 illustrates a flowchart illustrating the flow of the processing according to the exemplary embodiment.

First, an administrator A of a shared workspace sets a role in the shared workspace associated with an activity, by using the terminal device 12A of the administrator A (S01). The administrator A assigns a role to each user who participates in the activity. Information indicating the role setting and information indicating the role assignment are transmitted from the terminal device 12A to the server 10. The processor 20 of the server 10 associates the set role with the shared workspace and assigns the role to each user. The pieces of information are stored in the user information DB 30 and the WS information DB 32.

The processor 20 causes a screen showing the shared workspace to be displayed on the display of the terminal device 12 of each user participating in the activity associated with the shared workspace (S02). For example, users B and C are participating in the same activity. In a case where the user B accesses the shared workspace associated with the activity by using the terminal device 12B of the user B, the processor 20 causes the screen showing the shared workspace to be displayed on the display of the terminal device 12B. The same is applied to the user C.

In a case where the user B transmits an instruction to display a list of roles set in the shared workspace, by using the terminal device 12B, the processor 20 may cause the list to be displayed on the display of the terminal device 12B. Thus, the user B can check the role set for the activity in which the user B participates. The user B may set the content of the work to be performed in the activity. The same is applied to the user C.

The user B works on the shared workspace by using the terminal device 12B (S03). For example, the user B views a file, edits a file, and creates a new file on the shared workspace. The user B may transmit an instruction to assign the content of the work performed by the user B to the file, and the processor 20 may assign the content of the work performed by the user B to the file in accordance with the instruction. The user B may also select related materials. The related material is displayed on the screen showing the shared workspace. For example, the related material is displayed as a reference material. The user B may transmit an instruction to assign the content of the work performed by the user B to the related material. In this case, the processor 20 assigns the content of the work performed by the user B to the related material in accordance with the instruction. The same is applied to the user C.

Then, the user B uses the terminal device 12B to designate a user who receives a forwarded file and assigns the content of the work to the file, and to perform setting for notifying the designated user to a message of receiving the forwarded file and assigning the content of the work. Here, as an example, the user B designates the user C as a user who assigns the content of the work to the file. Information for identifying the file to which the content of the work is assigned and information indicating that the user who assigns the content of the work to the file is the user C are transmitted from the terminal device 12B to the server 10.

In a case where the setting of the notification is performed, and the user C is notified that the information indicating that the work content is assigned to the file (S04, Yes), the process proceeds to Step S05. For example, the user C is notified by e-mail, SNS, or the like, of information indicating that the content of the work is assigned to the file.

The above-described document α is an example of the file to which the content of the work is assigned. The above-described review is an example of the content of the work. The above-described request for the review is an example of the notification.

The processor 20 receives the information indicating that the user who assigns the content of the work to the file is the user C, and specifies the role assigned to the user C by referring to the user information DB 30. The processor 20 specifies a position at which the file to which the content of the work is assigned is displayed on the screen showing the shared workspace displayed on the display of the terminal device 12C of the user C (S05). The position corresponds to the role assigned to the user C. A display position is defined for each role, and information indicating the display position of each role is stored in the memory 18 of the server 10. The processor 20 specifies the display position corresponding to the role of the user C by referring to the information.

The processor 20 displays a file to which the content of the work is assigned, at a display position corresponding to the role of the user C on the screen showing the shared workspace displayed on the display of the terminal device 12C of the user C. For example, the document α being a target of review is displayed at a display position corresponding to the role of the user C.

The user C works on the shared workspace by using the terminal device 12C (S06). For example, it is conceivable that the user C refers to a file (for example, document α) as a target of assigning the content of the work and works on the file. The user C transmits an instruction to assign the content of the work to the file, by using the terminal device 12C. For example, the user C reviews the document α, and uses the terminal device 12C to transmit an instruction to assign the content of the work of reviewing the document α to the document α. The processor 20 receives the instruction, and associates the information indicating that the user C has reviewed the document α with the document α. In this manner, the content of the work performed by the user C is assigned to the document α.

In a case where the work (for example, a review) to be performed by the user C is ended (for example, in a case where the user C transmits an instruction to assign the content of the work to the document α, and the content of the work is assigned to the document α), the processor 20 specifies a position at which the file (for example, document α) on which the work has been completed is displayed on the screen showing the shared workspace displayed on the display of the terminal device 12B of the user B who requested the work (S08). The position corresponds to the role assigned to the user B, and the processor 20 specifies the display position corresponding to the role of the user B.

The processor 20 displays the file (for example, document α) to which the content of the work is assigned, at the display position corresponding to the role of the user B on the screen showing the shared workspace displayed on the display of the terminal device 12B of the user B (S09).

As described above, the file is displayed at the position corresponding to the role of the user. In addition, the content of the work is assigned to the file by the user who performed the work.

The processes of Steps S10 to S12 described below may or may not be executed. The processes of Steps S10 to S12 will be described below.

In a case where the user transmits an instruction to hand the work over by using the terminal device 12, the processor 20 causes the work performed by the user to be handed over to another user in accordance with the instruction (S10). For example, in a case where the user B hands over the work to the user D, the user B designates the user D to whom the work is handed over. The user D may be a user who has already participated in the activity in which the user B is participating, or may be a new user who participates in the activity by the administrator or the user B allowing this user to participate. The user B may use the terminal device 12B to leave a memo or the like on the screen showing the shared workspace displayed for the user B. The processor 20 saves the screen showing the shared workspace displayed on the display of the terminal device 12B of the user B.

Then, the administrator A changes a person in charge of performing the role assigned to the user B, from the user B to the user D in a manner that the administrator A uses the terminal device 12A to assign the role assigned to the user B, to the user D (S11). The role assigned to the user B is assigned to the user D, and information indicating that the role is not assigned to the user B is transmitted from the terminal device 12A to the server 10. In a case where the processor 20 receives the information, the processor 20 updates the information stored in the user information DB 30. That is, the information indicating the role assigned to the user B is associated with the user identification information of the user D, and is not associated with the user identification information of the user B.

Then, the processor 20 causes the screen showing the shared workspace to be displayed on the display of the terminal device 12D of the user D (S12). At this time, the processor 20 causes the screen showing the shared workspace which is displayed on the display of the terminal device 12B of the user B and is saved to be handed over, to be displayed on the display of the terminal device 12D. The user D works on the screen showing the shared workspace. For example, the user D checks the memo or the like left by the user B.

The exemplary embodiment will be described below in more detail with reference to specific examples.

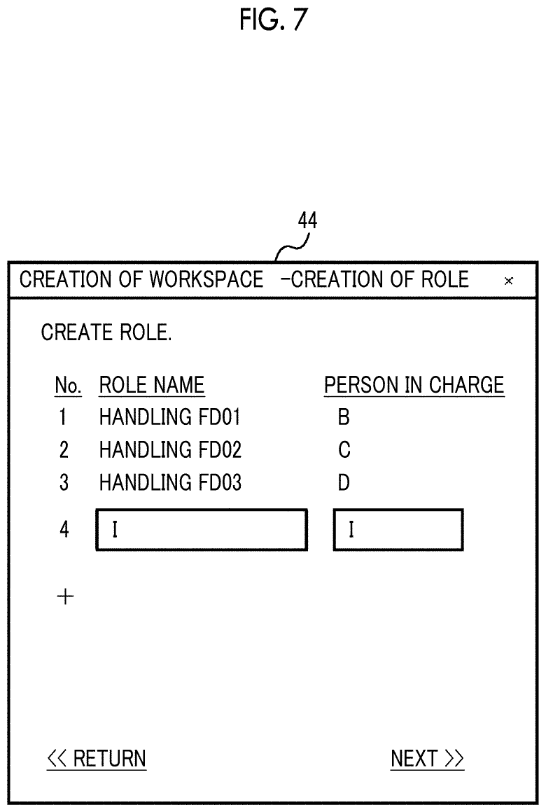

A procedure of setting a role in a shared workspace associated with an activity will be described with reference to FIGS. 7 to 10. FIGS. 7 to 10 illustrate a setting screen of a role.

Here, as an example, a project referred to as “Product Development A”, a project referred to as “Product Development B”, and a project referred to as “Product Development C” are defined as examples of activities. A user who is a participant of each project performs work corresponding to the role assigned to the user in the project.

A shared workspace is set for each project. That is, the processor 20 forms a shared workspace associated with the project “Product Development A”, forms a shared workspace associated with the project “Product Development B”, and forms a shared workspace associated with the project “Product Development C”. Information regarding the shared workspace associated with each project is stored in the WS information DB 32. Information regarding the user who participates in each project (that is, a user who uses the shared workspace associated with each project) is stored in the user information DB 30.

As described in Step S01 illustrated in FIG. 6, the administrator A assigns a role to each user participating in each project, by using the terminal device 12A of the administrator A. Here, as an example, the administrator A manages the shared workspaces of the respective projects “Product Development A”, “Product Development B”, and “Product Development C”. Another administrator may manage the shared workspace and assign the role to each user.

For example, the administrator A accesses the server 10 by using the terminal device 12A of the administrator A, and requests the server 10 to display the setting screen of the role. The processor 20 causes the setting screen of the role to be displayed on the display of the terminal device 12A in response to the request. For example, a setting screen 44 illustrated in FIG. 7 is displayed on the display of the terminal device 12A.

The setting screen 44 is a screen for setting a role required for the project and a user (for example, a person in charge) who performs the role. Here, as an example, the role required for the project “Product Development A” and the user who performs the role are set. For example, a list of projects is displayed on the display of the terminal device 12A, and the administrator A selects a project as a target of setting (for example, project “Product Development A”) from the list. The administrator A sets the role required for the project “product development A” on the setting screen 44, and further assigns the role to each user participating in the project “product development A”.

In the example illustrated in FIG. 7, roles “handling FD01”, “handling FD02”, and “handling FD03” have already been set as the roles required for the project “Product Development A”. The role “handling FD01” is assigned to the user B. The role “handling FD02” is assigned to the user C. The role “handling FD03” is assigned to the user D.

The administrator A may add a role required for the project “Product Development A” on the setting screen 44, and set a user who performs the added role. For example, the field of each of a role and a person in charge corresponding to “No. 4” is blank. In a case where the role name and the name of the person in charge are entered in the blanks, a new role and a new person in charge are set.

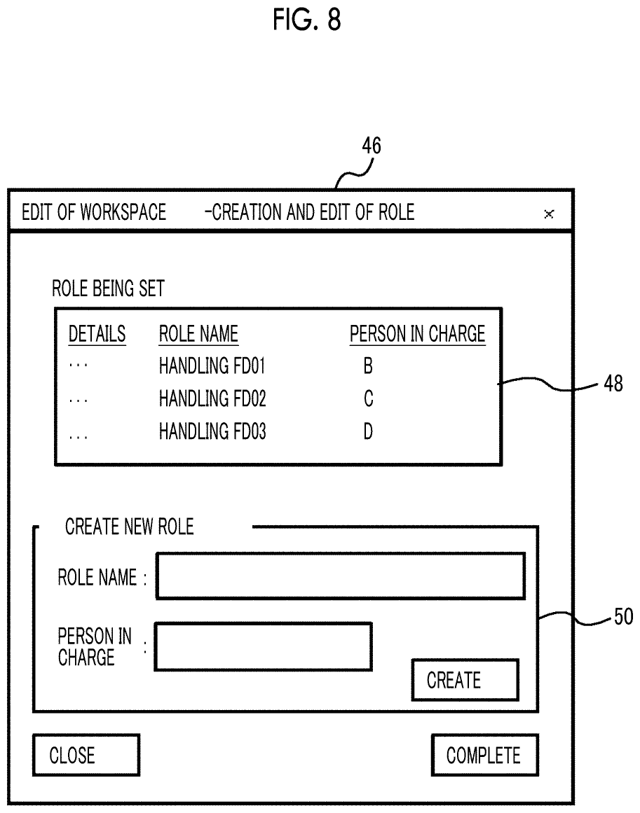

Instead of the setting screen 44 illustrated in FIG. 7, a setting screen 46 illustrated in FIG. 8 may be displayed on the display of the terminal device 12A of the administrator A. The setting screen 46 includes a display area 48 and an input field 50. In the display area 48, a list of the roles and the persons in charge that have already been set is displayed. The input field 50 is a field for setting a new role and a new person in charge, and is a field in which the role name and the name of the person in charge are input.

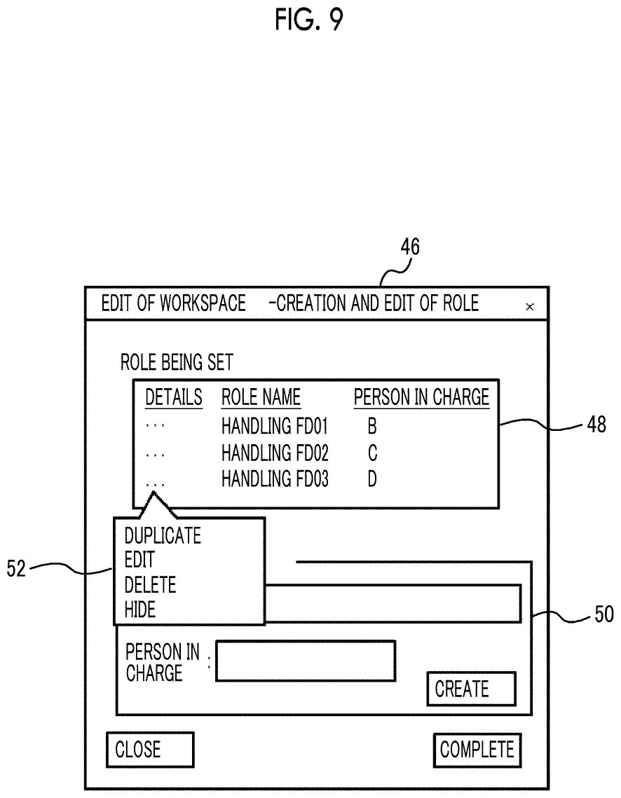

In a case where an item “details” displayed in the display area 48 is selected by the administrator A (for example, in a case where an operation such as clicking or touching is performed), as illustrated in FIG. 9, a list 52 of operations is displayed. The list 52 includes operations such as duplication, editing, deletion, and hiding of the role and the person in charge.

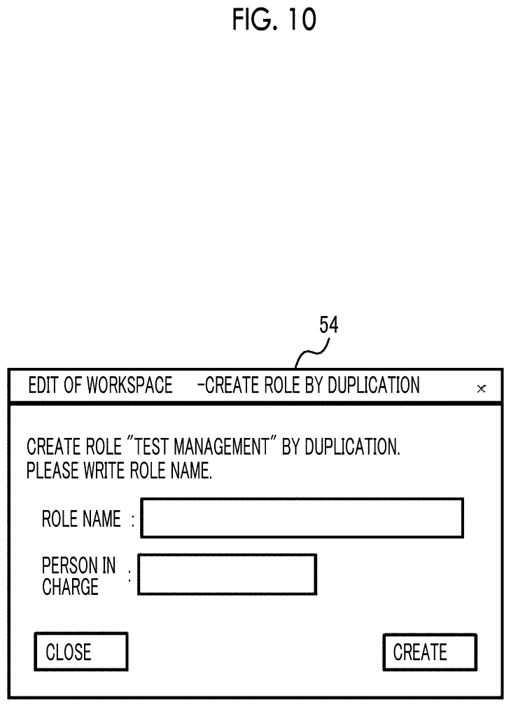

For example, in a case where “duplicate” included in the list 52 is selected by the administrator A, the processor 20 causes a setting screen 54 to be displayed on the display of the terminal device 12A, as illustrated in FIG. 10. The setting screen 54 is a screen for setting a new role by duplicating a role, and includes an input field for each of the role name and the name of the person in charge. In a case where the role name and the name of the person in charge are input on the setting screen 54 and the administrator A transmits an instruction to create a role, the role having the role name and the person in charge are newly set.

In a case where each role and the user who performs the role are set on the setting screens 44 and 46, the processor 20 associates each role with the shared workspace associated with the project “Product Development A” and assigns each role to each user. The pieces of information are stored in the user information DB 30 and the WS information DB 32.

In the example illustrated in FIG. 7, information indicating that users B, C, and D participate in the project “Product Development A” being an example of the activity, the users B, C, and D use a shared workspace associated with the project “Product Development A”, the role “handling FD01” is assigned to the user B, the role “handling FD02” is assigned to the user C, and the role “handling FD03” is assigned to the user D is stored in the user information DB 30.

For example, user identification information for identifying the user B, activity identification information for identifying the project “Product development A”, and workspace identification information for identifying the shared workspace associated with the project “Product development A”, and role identification information for identifying the role “handling FD01” assigned to the user B are stored in the user information DB 30 in association with each other. The content of the work to be performed by the user B to whom the role “handling FD01” is assigned, in the project “Product development A” may be designated by the administrator A. In this case, the work content identification information for identifying the content of the work is associated with the user identification information or the like of the user B. Similarly, for the users C and D, information regarding the user is stored in the user information DB 30. Such associations may be changed by the administrator A or each user. For example, the content of the work may be changed by the user to whom the content of the work is assigned.

The workspace identification information for identifying the shared workspace associated with the project “Product Development A” and the role identification information for identifying the role set on the setting screens 44 and 46 are stored in the WS information DB 32 in association with each other. In a case where the storage location of the work or a file to be used in the shared workspace is designated or specified, the storage location identification information for identifying the storage location may be associated with the workspace identification information or the like.

Similarly, for the projects “Product Development B” and “Product Development C”, each role required for the project and a user who performs each role are set.

The processor 20 may display a list of projects registered in the server 10 and a list of roles associated with the projects on the display of the terminal device 12 of the user.

For example, in a case where the user B accesses the server 10 by using the terminal device 12B of the user B and transmits an instruction to display a list of projects or a list of roles, the processor 20 causes the list of projects or the list of roles to be displayed on the display of the terminal device 12B in response to the instruction. The processor 20 may cause a list of projects in which the user B participates to be displayed on the display of the terminal device 12B, or may cause a list of projects registered in the server 10 regardless of whether or not the user B participates to be displayed on the display of the terminal device 12B. Alternatively, the processor 20 may cause a list of projects satisfying a search condition to be displayed on the display of the terminal device 12B. The processor 20 may cause the list designated by the user B to be displayed on the display of the terminal device 12B.

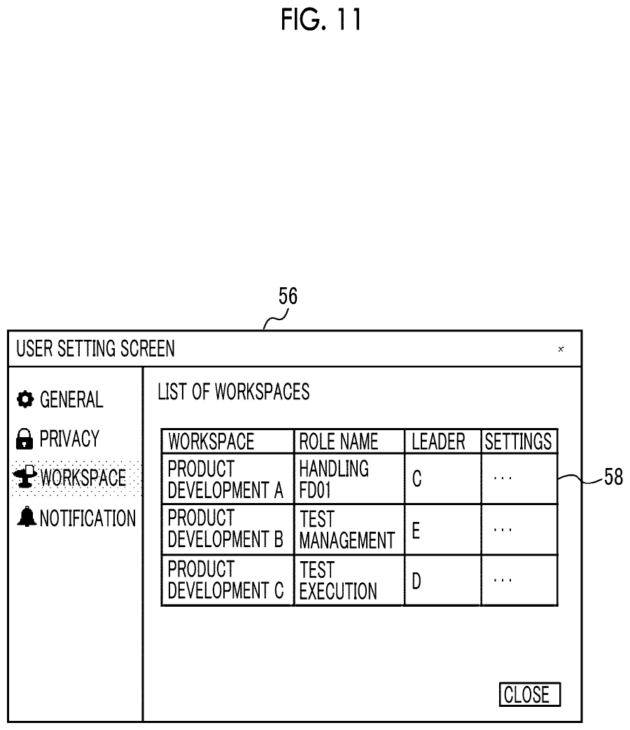

FIG. 11 illustrates a screen 56 for displaying the list of projects in which the user B participates. For example, in a case where the user B transmits an instruction to display a list of projects in which the user B participates, by using the terminal device 12B, the processor 20 searches for activity identification information and workspace identification information associated with the user identification information of the user B in the user information DB 30 to specify the project being an example of the activity in which the user B participates, and the shared workspace associated with the searched project. The processor 20 causes a screen 56 showing a list of the specified projects to be displayed on the display of the terminal device 12B.

In the example illustrated in FIG. 11, a list 58 of shared workspaces is displayed on the screen 56 as the list of projects. For example, the name of the project is used as the name of the shared workspace associated with the project, and the list 58 of names is displayed on the screen 56.

In the example illustrated in FIG. 11, the user B is permitted to participate in the projects “Product Development A”, “Product Development B”, and “Product Development C”, and to use the shared workspaces associated with the respective projects “Product Development A”, “Product Development B”, and “Product Development C”. In the project “Product Development A”, the role “handling FD01” is assigned to the user B. In the project “Product Development B”, the role “test management” is assigned to the user B. In the project “Product Development C”, the role “test execution” is assigned to the user B. That is, it is assumed that the user B performs the work corresponding to the role “handling FD01” in the project “Product Development A”, performs the work corresponding to the role “test management” in the project “Product Development B”, and performs the work corresponding to the role “test execution” in the project “Product Development C”. In addition, a leader is defined for each project, and the name, the ID, and the like of each leader are included in the list 58.

Similarly, for other users (for example, users C and D), a list of projects in which the other user participates is displayed on the display of the terminal device 12 of the other user. For example, in a case where the user C transmits an instruction to display the list of projects, the list of projects in which the user C participates is displayed on the display of the terminal device 12C of the user C.

The content of the work may be changed, added, or deleted by the user. In the example illustrated in FIG. 11, the list 58 includes setting items for each project (that is, for each shared workspace). In a case where the user B designates the item (for example, in a case where an operation such as clicking or touching is performed), the processor 20 causes a screen for changing, adding, or deleting the content of the work performed by the user B, which is associated with the designated item in the project, to be displayed on the display of the terminal device 12B.

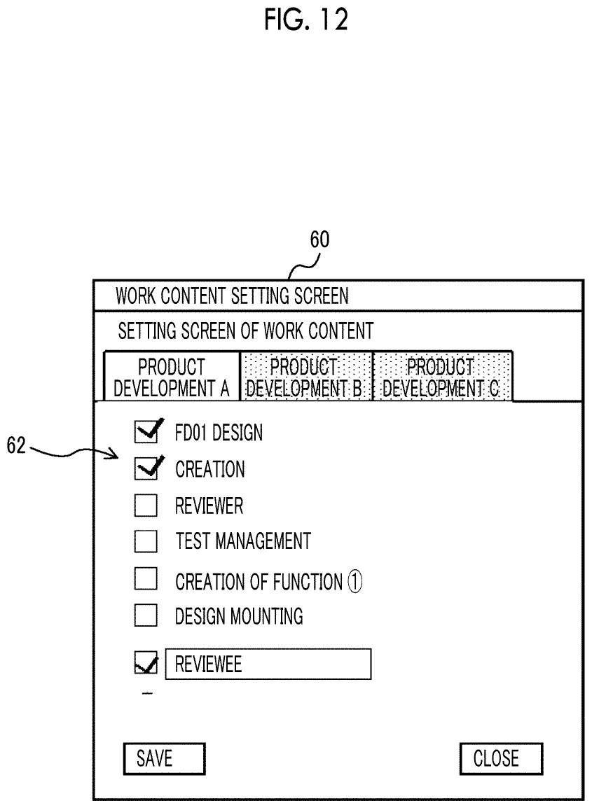

FIG. 12 illustrates a screen 60 for changing, adding, or deleting the content of the work. The screen 60 is a screen for changing, adding, or deleting the content of the work performed by the user B. Here, as an example, on the screen 56 illustrated in FIG. 11, the setting item corresponding to the project “Product Development A” is designated by the user B. In this case, the screen 60 is a screen for changing, adding, or deleting the content of the work performed by the user B in the project “Product Development A”.

For example, a list 62 of the contents of the work is displayed on the screen 60. The content of each work included in the list 62 is, for example, the content of the work expected to be performed by the user to whom the role “handling FD01” is assigned in the project “Product Development A”. For example, the content of the work expected to be performed is defined in advance for each project and each role, and information indicating the predefined content is stored in the memory 18 of the server 10. By referring to the information, the processor 20 specifies the content of the work expected to be performed by the user to whom the role “handling FD01” is assigned in the project “Product Development A”. Then, the processor 20 displays the list 62 of the content of the specified work, on the screen 60. The content of the work other than the content of the predefined work may be added as the content of the work performed by the user B, on the screen 60.

A check mark is put to the content of the work assigned to the user B. For example, work contents “FD01 design”, “creation”, and “reviewee” are assigned to the user B as the contents of the work performed by the user B to whom the role “handling FD01” is assigned in the project “product development A”. The work content “reviewee” is not the content of the predefined work, but the content of the work newly added by the user B.

On the screen 60, the user B adds the content of the work performed by the user B or deletes the content of the work that is not performed by the user B. For example, the user B puts a check mark on the content of the work performed by the user B, and removes the check mark from the content of the work that is not performed by the user B.

In a case where a check mark is put to the work content such as the work content “FD01 design”, the processor 20 associates work content identification information for identifying the content of the work to which the check mark is put, with the user identification information of the user B, the activity identification information of the project “Product Development A”, and the workspace identification information of the shared workspace associated with the project “Product Development A”, and then stores the result of the association in the user information DB 30.

In the example illustrated in FIG. 12, check marks are put to the work contents “FD01 design”, “creation”, and “reviewee”, and thus the work contents “FD01 design”, “creation”, and “reviewee” are designated as work performed by the user B to whom the role “handling FD01” is assigned in the project “Product Development A”. In this case, the processor 20 associates the work content identification information for identifying each of the work contents “FD01 design”, “creation”, and “reviewee”, with the user identification information of the user B, the activity identification information of the project “Product Development A”, and the workspace identification information of the shared workspace associated with the project “Product Development A”, and then stores the result of the association in the user information DB 30.

The administrator A may add, change, or delete the contents of the work performed by each user. For example, the administrator A may add, change, or delete the contents of the work performed by the user B on the screen 60.

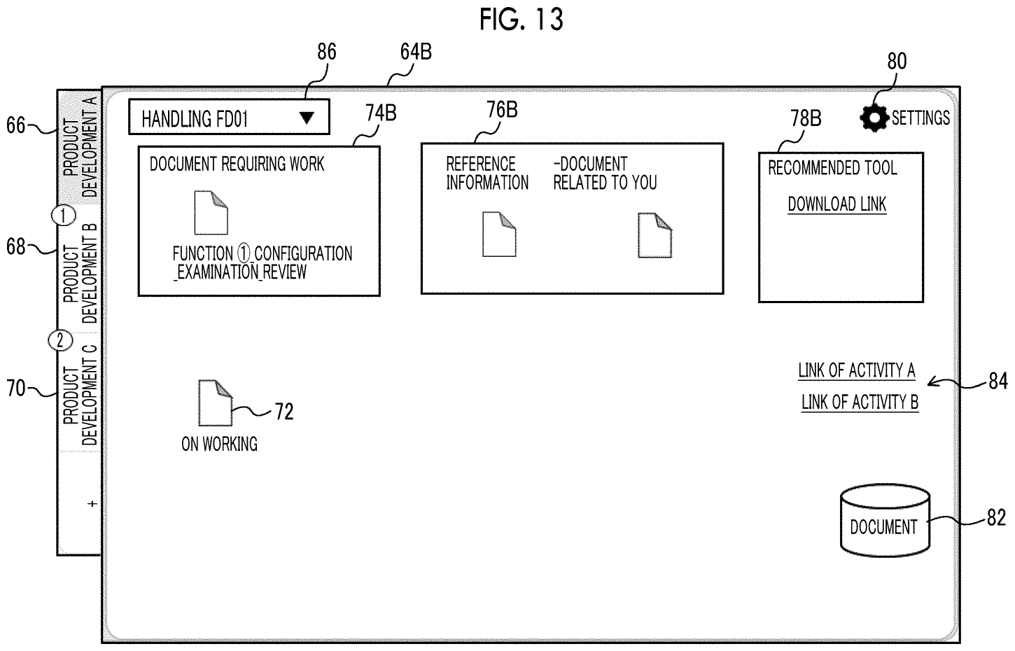

The screen showing the shared workspace will be described below with reference to FIG. 13. FIG. 13 illustrates a screen 64B. Here, as an example, the screen 64B is a screen displayed on the display of the terminal device 12B of the user B. For example, the user B accesses the server 10 by using the terminal device 12B and requests the display of the shared workspace associated with the user B. In response to the request, the processor 20 causes the screen 64B of the shared workspace associated with the user B to be displayed on the display of the terminal device 12B.

Files, folders, functions, and the like associated with the shared workspace are displayed on the screen 64B. For example, the processor 20 refers to the user information DB 30 to specify the shared workspace associated with the user B, refers to the WS information DB 32 to specify the storage location identification information associated with the shared workspace, and then displays a file stored in the storage location indicated by the storage location identification information, on the screen 64B. As described above, the work or the file to be used in the shared workspace associated with the user B is displayed on the screen 64B. The file is displayed at a position corresponding to the role assigned to the user B, on the screen 64B.

On the screen 64B, the activity associated with the user B is switched, and the shared workspace associated with the user B is switched. For example, the user B participates in the projects “Product Development A”, “Product Development B”, and “Product Development C”, and a shared workspace corresponding to each project is formed. Tabs 66, 68, and 70 are provided on the screen 64B, and the shared workspace can be switched by designating the tabs. For example, the tab 66 is associated with the project “Product Development A”, the tab 68 is associated with the project “Product Development B”, and the tab 70 is associated with the project “Product Development C”. In a case where the tab 66 is designated by the user B, the processor 20 displays the shared workspace associated with the project “Product Development A”, on the screen 64B. The processor 20 refers to the WS information DB 32 to specify the storage location associated with the project “Product Development A”, and displays the file stored in the storage location, on the screen 64B. In a case where the tab 68 is designated, the processor 20 displays the shared workspace associated with the project “Product Development B” on the screen 64B, and displays the file associated with the project “Product Development B” on the screen 64B. The same is applied to a case where the tab 70 is designated. As described above, by switching the shared workspace, the file displayed on the screen 64B can be switched. That is, by switching the project, the file to be worked on and the file to be used in the project can be switched.

On the screen 64B, for example, a file 72 being worked on (for example, an image such as an icon representing the file 72), display areas 74B, 76B, and 78B, a setting button 80, a storage location 82 of the file (for example, an image such as an icon representing the storage location 82), a link group 84, and a switching button 86 are displayed. These are merely examples, and a plurality of files and folders may be displayed on the screen 64B. Further, an image such as an icon representing a function may be displayed on the screen 64B. For example, an image such as an icon representing a program such as application software for realizing the function may be displayed on the screen 64B. Specifically, an image such as an icon representing document creation application software or an image such as an icon representing image processing application software may be displayed on the screen 64B.

The file 72 is, for example, document data and is being worked on by the user B. For example, a document such as a function specification is created by the user B.

The display area 74B is an area in which a file (for example, document data) that requires work is displayed. For example, the processor 20 displays a file to be worked on by the user B to whom the role “handling FD01” is assigned in the project “Product Development A”, in the display area 74B. In the example illustrated in FIG. 13, a document “Function1_Configuration_Examination_Review” being document data is displayed in the display area 74B as an example of the file.

For example, in a case where the user B is set as a user who assigns the content of the work to the document “Function1_Configuration_Examination_Review”, the processor 20 displays the document “Function1_Configuration_Examination_Review” in the display area 74B. For example, in a case where the user B is requested to review the document “Function1_Configuration_Examination_Review” as the content of the work for the document “Function1_Configuration_Examination_Review”, the processor 20 displays the document “Function1_Configuration_Examination_Review” in the display area 74B.

In a case where the user B requests another user to assign the content of the work to the document “Function1_Configuration_Examination_Review”, and the other user assigns the content of the work to the document “Function1_Configuration_Examination_Review”, the processor 20 may display the document “Function1_Configuration_Examination_Review” to which the content of the work has been assigned in the display area 74B.

Reference information is displayed in the display area 76B. For example, the processor 20 displays a file such as a document related to the role “handling FD01” assigned to the user B in the project “Product Development A”, in the display area 76B as the reference information. The processor 20 may display a file created by the user B, a file previously used as the reference by the user B, a file used for the project “Product Development A”, and the like in the display area 76B.

A tool such as a function is displayed in a display area 78B. For example, the processor 20 displays a tool such as a function related to the role “handling FD01” assigned to the user B in the project “Product Development A”, in the display area 78B. In the example illustrated in FIG. 13, a link (for example, a URL) for downloading the tool is displayed in the display area 78B.

The setting button 80 is a button for the user to issue instructions for various settings. For example, a setting of handling over the role is performed. The handover will be described later in detail.

The storage location 82 is a storage location for a file. For example, the storage location 82 is a storage location in which the work or a file to be used in the shared workspace associated with the project “Product Development A” are stored. Further, a file such as a document for which the work has been completed may be stored in the storage location 82.

The link group 84 includes various links (for example, URLs). For example, the link group 84 includes links of another activity or the like.

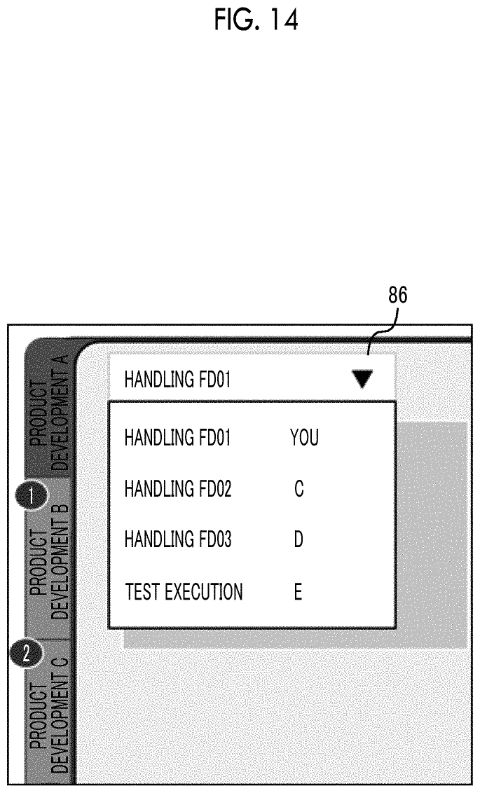

The switching button 86 is a button for switching the screen of the shared workspace. In a case where the switching button 86 is pressed by the user, the processor 20 displays a list of users participating in the project “Product Development A”. FIG. 14 illustrates the list. In the example illustrated in FIG. 14, the list includes the user B (you) to whom the role “handling FD01” is assigned, the user C to whom the role “handling FD02” is assigned, the user D to whom the role “handling FD03” is assigned, and the user E to whom the role “test execution” is assigned.

In a case where the user B selects a user other than the user B from the list, the processor 20 causes the screen of the shared workspace displayed for the selected user to be displayed on the display of the terminal device 12B. For example, in a case where the user B selects the user C, the processor 20 causes the screen showing the shared workspace displayed for the user C to be displayed on the display of the terminal device 12B instead of the screen 64B illustrated in FIG. 13. In this manner, it is possible to cause the user to check the shared workspace displayed for another user.

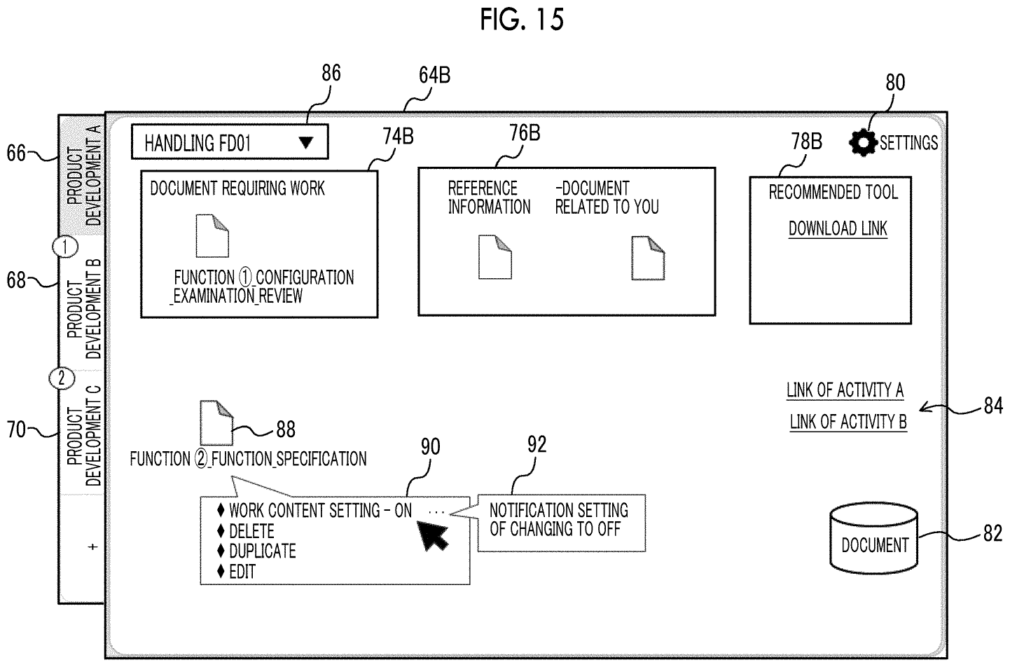

The setting of whether or not to display a screen for assigning the content of the work to a file will be described below with reference to FIG. 15. The screen for assigning the content of the work to a file is referred to as a “work content assignment screen”. FIG. 15 illustrates the screen 64B of the shared workspace displayed for the user B, similar to FIG. 14. For example, the user B uses the terminal device 12B to designate a user who receives a forwarded file and assigns the content of the work to the file, and perform setting for notifying the designated user to a message of receiving the forwarded file and assigning the content of the work.

In the example illustrated in FIG. 13, the user B works on the file 72. A file 88 illustrated in FIG. 15 is a file for which the work has been completed. The file 88 referred to as the document “Function2_Function_Specification” is created by the user B working on the file 72.

Here, as an example, the user B forwards the file 88 for which the work by the user B has been completed to another user, and requests the other user to assign the content of the work to the file 88. For example, the user B designates the other user and performs a setting of notifying the other user to assign the content of the work to the file 88. The file 88 corresponds to an example of the first file.

For example, the user B clicks the file 88 or the like to transmit an instruction to display a menu 90. The menu 90 includes a function of assigning the content of the work to the file 88 and other functions (for example, deletion).

In a case where the user B selects a function of assigning the content of the work to the file 88 from the menu 90, and turns on the function, and then in a case where the file 88 is opened and then closed, the work content assignment screen is displayed. That is, turning on the function means displaying the work content assignment screen when the file 88 is closed the next time.

In addition, a setting of notifying the user who assigns the content of the work to the file 88 that the display of the work content assignment screen is set may be performed. For example, in a case where the user B turns on the function of assigning the content of the work, a menu 92 is displayed. The menu 92 includes a setting item for turning off the function and a setting item for a notification that the display of the work content assignment screen is set.

In a case where “off” included in the menu 92 is designated by the user B, the function of assigning the content of the work is turned off, and the work content assignment screen is not displayed.

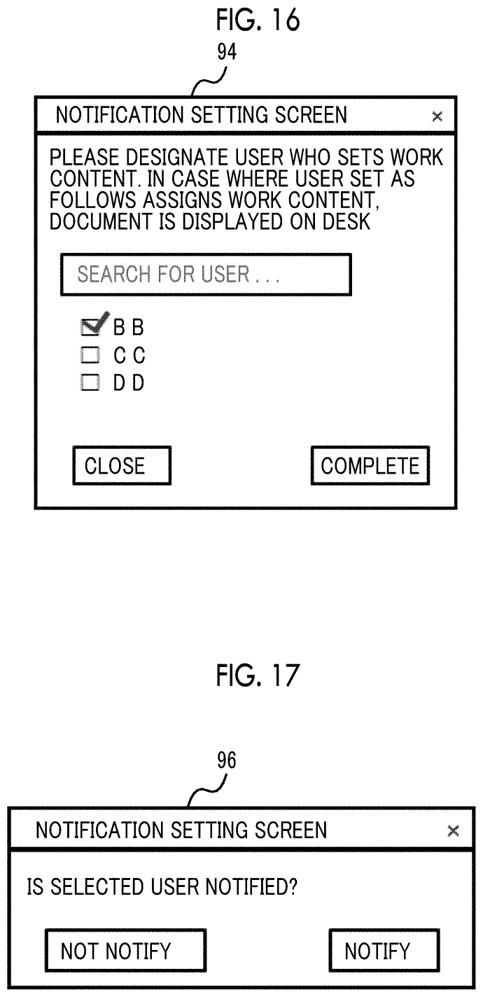

In a case where “notification setting” included in the menu 92 is designated by the user B, the processor 20 causes a screen for setting a notification (referred to as a “notification setting screen” below) to be displayed on the display of the terminal device 12B. FIG. 16 illustrates a notification setting screen 94.

A list of other users participating in the project “Product Development A” in which the user B participates is displayed on the notification setting screen 94. For example, the user identification information of each of the users C, D, and E is displayed on the notification setting screen 94.

The user B designates the user who assigns the content of the work to the file 88 from the users C, D, and E. In the example illustrated in FIG. 16, the user C is designated.

In a case where the user C assigns the content of the work to the file 88, the file 88 to which the content of the work is assigned is displayed on the screen 64B showing the shared workspace displayed for the user B. A message indicating that the user who assigns the content of the work is designated, and the designated user assigns the content of the work is displayed on the notification setting screen 94.

In a case where the user B presses a completion button on the notification setting screen 94 while the user (for example, user C) who assigns the content of the work is designated, the processor 20 causes the notification setting screen 96 to be displayed on the display of the terminal device 12B, as illustrated in FIG. 17. Whether or not to notify the user who assigns the content of the work that the display of the work content assignment screen has been set is set on the notification setting screen 96. In a case where a notification button is pressed by the user B, the user C is notified that the display of the work content assignment screen has been set. For example, the processor 20 transmits, to the user C, information indicating that the user C is designated as the user who assigns the content of the work to the file 88 and information indicating that the display of the work content assignment screen is set for the file 88. For example, the processor 20 transmits such pieces of information to the user C by means such as e-mail or an SNS. For example, the pieces of information are displayed on the display of the terminal device 12C of the user C.

The processor 20 associates the file 88 with information indicating that the work content assignment screen is set to be displayed and information indicating that the user C is the user who assigns the content of the work. The user B corresponds to an example of the first user, and the user C corresponds to an example of the second user.

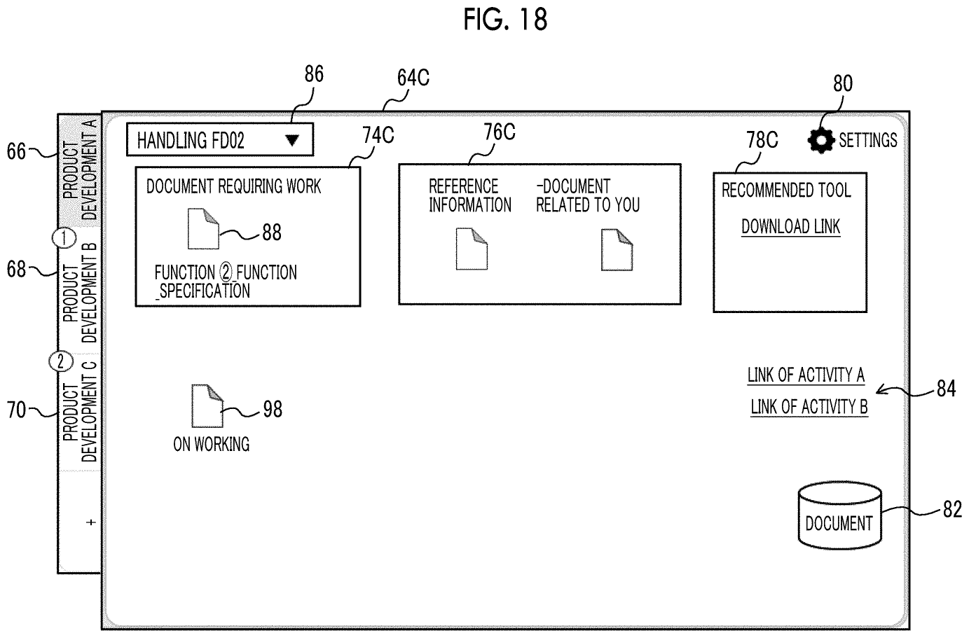

A screen showing the shared workspace, which is displayed for the user C, will be described below with reference to FIG. 18. FIG. 18 illustrates a screen 64C. The screen 64C is a screen displayed on the display of the terminal device 12C of the user C. For example, the user C accesses the server 10 by using the terminal device 12C and requests the display of the shared workspace associated with the user C. In response to the request, the processor 20 causes the screen 64C of the shared workspace associated with the user C to be displayed on the display of the terminal device 12C.

Files, folders, functions, and the like associated with the shared workspace are displayed on the screen 64C. For example, the processor 20 refers to the user information DB 30 to specify the shared workspace associated with the user C, refers to the WS information DB 32 to specify the storage location identification information associated with the shared workspace, and then displays a file stored in the storage location indicated by the storage location identification information, on the screen 64C. As described above, the work or the file to be used in the shared workspace associated with the user C is displayed on the screen 64C. The file is displayed at a position corresponding to the role assigned to the user C, on the screen 64C.

The user C participates in the same project as the project of the user B, and tabs 66, 68, and 70 for switching projects are displayed. A file 98 being worked on (for example, an image such as an icon representing the file 98), display areas 74C, 76C, and 78C, a setting button 80, a storage location 82, a link group 84, and a switching button 86 are displayed on the screen 64C.

The display area 74C is an area in which a file (for example, document data) that requires work is displayed. The role “handling FD02” is assigned to the user C. The processor 20 displays, for example, a file to be worked on by the user C to whom the role “handling FD02” is assigned in the project “Product Development A”, in the display area 74C.

In the example illustrated in FIG. 18, a file 88 referred to as the document “Function2_Function_Specification” is displayed in the display area 74C. As described with reference to FIGS. 15 and 16, in the file 88 created by the user B, the user C is set as the user who assigns the content of the work, and the display of the work content assignment screen is set. That is, the user C is set as the user who assigns the content of the work to the file 88 referred to as the document “Function2_Function_Specification”. For example, in a case where the user C is requested to review the document “Function2_Function_Specification” as the content of the work for the document “Function2_Function_Specification”, the processor 20 displays the document “Function2_Function _Specification” in the display area 74C.

Reference information is displayed in the display area 76C. For example, the processor 20 displays a file such as a document related to the role “handling FD02” assigned to the user C in the project “Product Development A”, in the display area 76C as the reference information. The processor 20 may display a file created by the user C, a file previously used as the reference by the user C, a file used for the project “Product Development A”, and the like in the display area 76C.

As described above, the processor 20 changes the position at which the file is displayed, depending on the role of the user. That is, the file to be worked on by the user B to whom the role “handling FD01” is assigned is displayed in the display area 74B displayed for the user B. The file to be worked on by the user C to whom the role “handling FD02” is assigned is displayed in the display area 74C displayed for the user C. Similarly, the file related to the role “handling FD01” is displayed in the display area 76B, and the file related to the role “handling FD02” is displayed in the display area 76C. For example, the file displayed in the display area 74B is displayed in the display area 76C, and the file displayed in the display area 74C is displayed in the display area 76B. As described above, the processor 20 changes the position at which the file is displayed, depending on the role.

The procedure for assigning the content of the work to the file will be described below. In a case where the user transmits an instruction to close the opened file by using the terminal device 12 (for example, in a case where the user presses a close button), the processor 20 closes the file and causes the work content assignment screen to be displayed on the display of the terminal device 12.

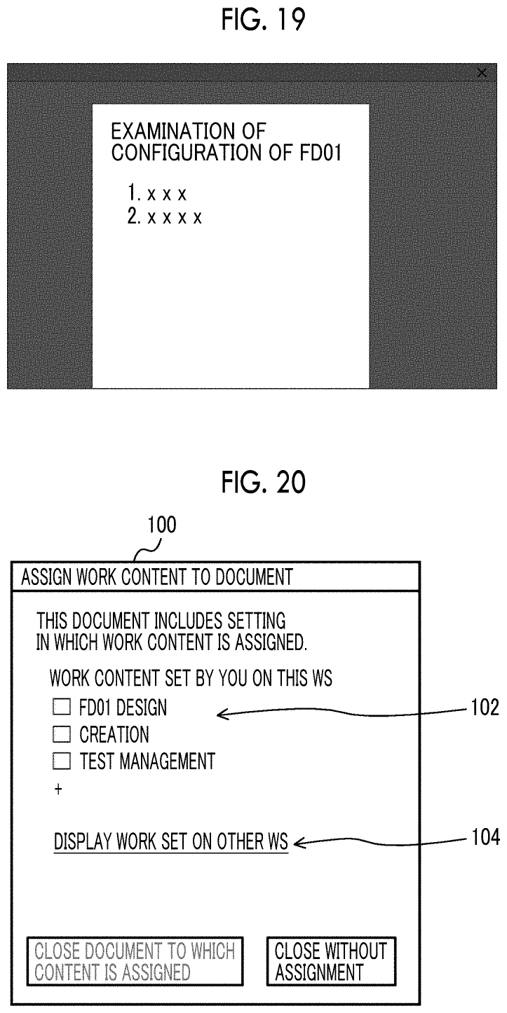

For example, in a case where the user B opens the file (for example, the file 72) displayed on the screen 64B and closes the opened file 72, the processor 20 closes the file 72. In a case where displaying the work content assignment screen is set for the file 72, the processor 20 causes the work content assignment screen to be displayed on the display of the terminal device 12B. For example, as illustrated in FIG. 19, in a case where the content of a document being an example of the file 72 is displayed on the screen 64B, and the user B closes the document, the processor 20 causes the work content assignment screen to be displayed on the display of the terminal device 12B.

FIG. 20 illustrates a work content assignment screen 100. The user B can assign the content of the work to the file 72 on the work content assignment screen 100. For example, work content identification information for identifying the content of the work to be performed by the user B in the shared workspace is displayed on the work content assignment screen 100. The processor 20 refers to the user information DB 30 to specify the work content identification information for identifying the content of the work to be performed by the user B in the shared workspace (for example, the shared workspace associated with the project “Product Development A”), and displays a list 102 of pieces of the specified work content identification information on the work content assignment screen 100. Here, as an example, the work contents “FD01 design”, “creation”, and “test management” are set as the contents of the work to be performed by the user B.

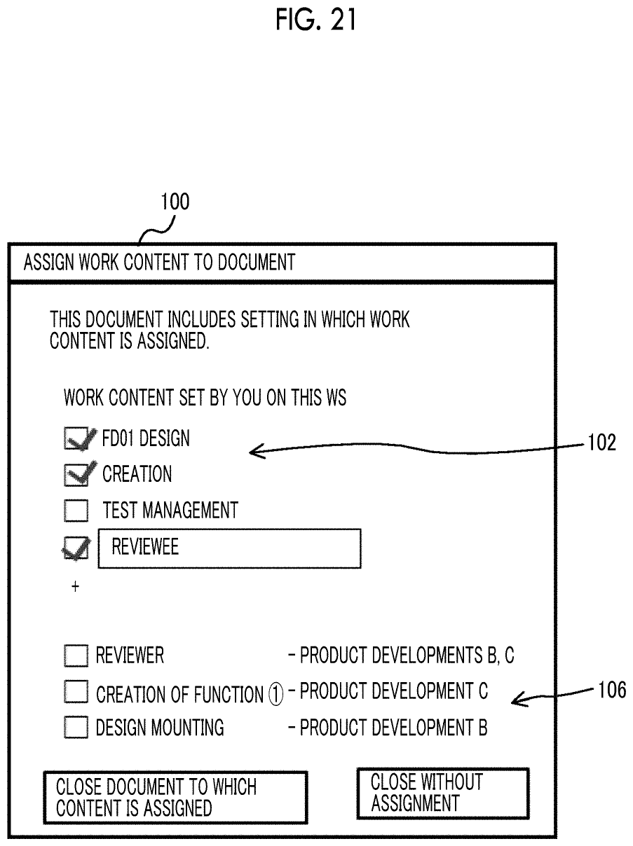

A button 104 for displaying the content of the work to be performed by the user B in another shared workspace is displayed on the work content assignment screen 100. In a case where the button 104 is pressed by the user, the processor 20 displays a list of pieces of work content identification information for identifying the contents of the work to be performed by the user B in another shared workspace (for example, a shared workspace associated with each of the projects “Product Development B” and “Product Development C”) on the work content assignment screen 100. FIG. 21 illustrates the list 106. Here, as an example, the list of pieces of the work content identification information indicating the contents of the work to be performed by the user B in each of the projects “Product Development B” and “Product Development C” is displayed.

The user B performs the work contents “FD01 design”, “creation”, and “reviewee” on the file 72, and the user B puts check marks to the work contents as illustrated in FIG. 21. The work content “reviewee” is the work content added by the user B on the work content assignment screen 100.

In a case where the user B assigns the work content to the file and transmits an instruction to close the file on the work content assignment screen 100, the processor 20 associates the file 72 with information indicating that the work contents “FD01 design”, “creation”, and “reviewee” have performed by the user B. Thus, the contents of the work performed by the user B are assigned to the file 72. In a case where the user B transmits an instruction to close the file without assigning the work content, on the work content assignment screen 100, the processor 20 does not assign the content of the work to the file 72.

The similar process is executed in a case where another user closes the file. For example, in a case where the user C opens the file 88 requested to be worked on by the user B on the screen 64C, the processor 20 causes the contents of the file 88 to be displayed on the display of the terminal device 12C. For example, in a case where the user C is requested to review the file 88, the user C refers to and reviews the contents of the file 88. In addition, it is conceivable to proofread the document, for example.

In a case where the user C transmits an instruction to close the file 88 by using the terminal device 12C (for example, in a case where the close button is clicked), the processor 20 closes the file 88 and causes the work content assignment screen to be displayed on the display of the terminal device 12C. A list of work to be performed by the user C in the project “Product Development A” is displayed on the work content assignment screen displayed for the user C. For example, in a case where the user C issues an instruction to assign the work content “review”, the processor 20 assigns, to the file 88, information indicating that the work content “review” has been performed by the user C. In a case where the work content “review” is assigned to the file 88, the processor 20 displays the file 88 to which the work content “review” is assigned, on the screen 64B showing the shared workspace provided for the user B. For example, the file 88 to which the work content “review” is assigned is displayed in the display area 74B in which the file requiring work is displayed, on the screen 64B. It is conceivable that the user B confirms the review of the user C.

The processor 20 may change the priority of the display of the file on the screens 64B and 62C, depending on the file. For example, in a case where a plurality of files are superimposed and displayed in the display area 74C illustrated in FIG. 18, the processor 20 changes the priority of the display of each file depending on the files. For example, the file 88 in which the notification is set has the highest priority of the display, and the processor 20 displays the file 88 in the foreground. As another example, the processor 20 may display an older file in the foreground.

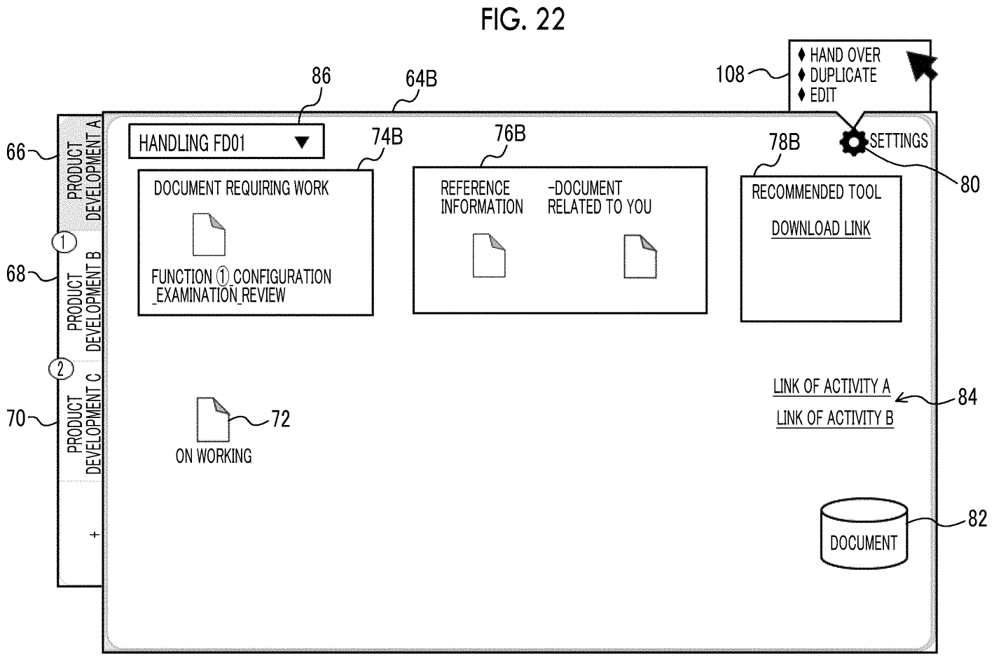

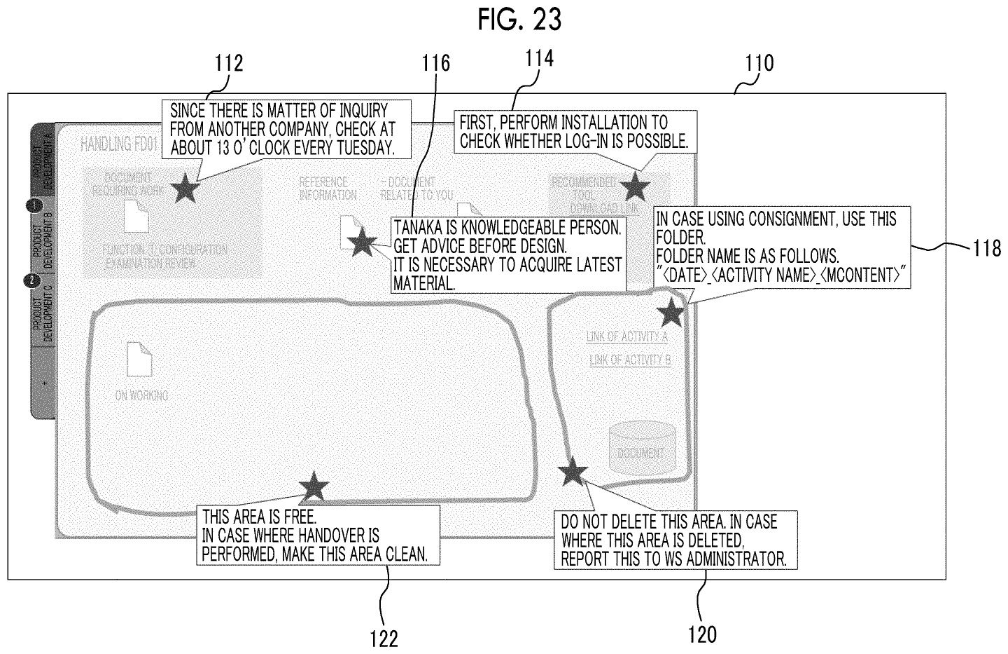

The handover of the role will be described below with reference to FIGS. 22 and 23. FIG. 22 illustrates the screen 64B showing the shared workspace. FIG. 23 illustrates an image 110 representing the screen 64B.

For example, in a case where the user B presses the setting button 80 displayed on the screen 64B, a menu 108 is displayed. The menu 108 includes a “handover” function. In a case where the user B designates the “handover” function (for example, in a case where “handover” is clicked), the processor 20 executes a process of handling the role over. Handling the role over means assigning the role of one user to another user different from the user. Here, as an example, the role of the user B is handed over to the user D. That is, the role of the user B is assigned to the user D. The user B corresponds to the third user, and the user D corresponds to the fourth user. In a case where the role of the user B is handed over to the user D, the role may not be assigned to the user B. In this case, the user D performs the work in accordance with the role, and the user B does not perform the work in accordance with the role any more. Even in a case where the role of the user B is handed over to the user D, the role may be assigned to the user B.

The processor 20 displays the same content as the content displayed for the user B, for the user D. The processor 20 saves the content displayed on the screen 64B illustrated in FIG. 22 and causes the saved content to be displayed on the display of the terminal device 12D of the user D. That is, a screen having the same content as the content of the screen 64B is displayed on the display of the terminal device 12D of the user D.

For example, the administrator A or the user B assigns the role of the user B to the user D on the setting screen 44. Specifically, the user to whom the role “handling FD01” is assigned is changed from the user B to the user D on the setting screen 44. Thus, the role “handling FD01” of the user B is assigned to the user D and is not assigned to the user B. Thus, the role “handling FD01” is handed over from the user B to the user D.

The role is handed over to another user for each activity, for example. A role in one activity may be handed over to another user, and another role may not be handed over to another user. For example, the role in at least one of the projects “Product Development A”, “Product Development B”, or “Product Development C” may be handed over from the user B to the user D. One role may be handed over from the user B to the user D, and another role may be handed over from the user B to a user other than the user D. Here, as an example, the role of the user “handling FD01” in the project “Product Development A” is handed over to the user D.

In a case where the user uses the terminal device 12D to access the shared workspace associated with the project “Product Development A”, the processor 20 causes the screen 64B displayed for the user B to be displayed on the display of the terminal device 12D.

In a case where the user B adds information such as a text string or an image on the screen 64B, the processor 20 causes the screen 64B in a state in which the added information is applied, to be displayed on the display of the terminal device 12D of the user D.

The processor 20 may generate image data of the screen 64B to which the information such as a text string and an image is added, and transmit the image data to the user D. For example, the image data is transmitted to the user D by e-mail, the SNS, or the like.

FIG. 23 illustrates an image 110 representing the screen 64B. Here, as an example, before the role “handling FD01” of the user B is handed over to the user D, the user B adds memos 112, 114, 116, 118, 120, and 122 (referred to as a “memo 112 and the like” below) on the screen 64B. In a case where the user B transmits an instruction to hand over the role “handling FD01” of the user B to the user D, the processor 20 generates image data representing the screen 64B to which the memo 112 and the like are added, and transmits the image data to the user D. For example, the image data is displayed on the display of the terminal device 12D.

The processor 20 may cause the screen 64B to which the memo 112 or the like is added to be displayed on the display of the terminal device 12D. The user B can check the memo 112 and the like on the screen 64B.

The functions of the units of the server 10 and the terminal device 12 are realized by the cooperation of hardware and software as an example. For example, the processor of each device reads and executes the program stored in the memory of each device to realize the functions of each device. The program is stored in the memory via a recording medium such as a CD or a DVD, or via a communication path such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
display a first file necessary for work for a role of a user in performing an activity having a specific purpose, among files shared and worked on by a plurality of users; and
change a position at which the first file is displayed, depending on the role.

2. The information processing apparatus according to claim 1, wherein the processor is configured to:
in a case where the first file in which work has been completed by a first user is forwarded to a second user different from the first user, display the first file at a position corresponding to a role of the second user, for the second user.

3. The information processing apparatus according to claim 1, wherein the processor is further configured to:
change a display priority of the first file in accordance with the first file.

4. The information processing apparatus according to claim 2, wherein the processor is further configured to:
change a display priority of the first file in accordance with the first file.

5. The information processing apparatus according to claim 1, wherein the processor is further configured to:
in a case where a role of a third user is assigned to a fourth user different from the third user, display the same content as a content displayed for the third user, for the fourth user.

6. The information processing apparatus according to claim 2, wherein the processor is further configured to:
in a case where a role of a third user is assigned to a fourth user different from the third user, display the same content as a content displayed for the third user, for the fourth user.

7. The information processing apparatus according to claim 3, wherein the processor is further configured to:
in a case where a role of a third user is assigned to a fourth user different from the third user, display the same content as a content displayed for the third user, for the fourth user.

8. The information processing apparatus according to claim 4, wherein the processor is further configured to:
in a case where a role of a third user is assigned to a fourth user different from the third user, display the same content as a content displayed for the third user, for the fourth user.

9. The information processing apparatus according to claim 5, wherein the processor is further configured to:
display information added by the third user, for the fourth user.

10. The information processing apparatus according to claim 6, wherein the processor is further configured to:
display information added by the third user, for the fourth user.

11. The information processing apparatus according to claim 7, wherein the processor is further configured to:
display information added by the third user, for the fourth user.

12. The information processing apparatus according to claim 8, wherein the processor is further configured to:
display information added by the third user, for the fourth user.

13. The information processing apparatus according to claim 1, wherein the processor is further configured to:
display a list of contents of work corresponding to roles of the users, and
associate the content of the work selected from the list, with the user.

14. The information processing apparatus according to claim 2, wherein the processor is further configured to:
display a list of contents of work corresponding to roles of the users, and
associate the content of the work selected from the list, with the user.

15. The information processing apparatus according to claim 3, wherein the processor is further configured to:
display a list of contents of work corresponding to roles of the users, and
associate the content of the work selected from the list, with the user.

16. The information processing apparatus according to claim 4, wherein the processor is further configured to:
display a list of contents of work corresponding to roles of the users, and
associate the content of the work selected from the list, with the user.

17. The information processing apparatus according to claim 5, wherein the processor is further configured to:
display a list of contents of work corresponding to roles of the users, and
associate the content of the work selected from the list, with the user.

18. The information processing apparatus according to claim 6, wherein the processor is further configured to:
display a list of contents of work corresponding to roles of the users, and
associate the content of the work selected from the list, with the user.

19. A non-transitory computer readable medium storing a program causing a computer to operate to:
display a first file necessary for work for a role of a user in performing an activity having a specific purpose, among files shared and worked on by a plurality of users, and
change a position at which the first file is displayed, depending on the role.

20. An information processing method comprising:
displaying a first file necessary for work for a role of a user in performing an activity having a specific purpose, among files shared and worked on by a plurality of users; and
changing a position at which the first file is displayed, depending on the role.
